(19) United States
(12) Patent Application Publication
(10) Pub. No.: US 2025/0314549 A1
(43) Pub. Date: Oct. 9, 2025

(54) COLORIMETRIC GAS LEAK DETECTION

(71) Applicant: Edison Welding Institute, Inc., Columbus, OH (US)

(72) Inventors: Jeffrey L. Ellis, Columbus, OH (US); Jeffrey J. Boyce, Columbus, OH (US); Jerry E. Gould, Columbus, OH (US); Douglas M. Myers, Columbus, OH (US)

(21) Appl. No.: 19/171,686

(22) Filed: Apr. 7, 2025

Related U.S. Application Data
(60) Provisional application No. 63/631,134, filed on Apr. 8, 2024.

(51) Int. Cl. G01M 3/20

(52) U.S. Cl. CPC G01M 3/20

(57) ABSTRACT

A system for detecting gas leaks, comprising a chemical reagent that includes a saturated aqueous solution of a predetermined metal ionic powder; a flexible substrate configured to receive the chemical reagent, wherein the flexible is also configured to be affixed to the exterior of an item to be leak tested; a source of ozone gas, wherein the ozone gas is flowed into the item to be leak tested under a predetermined pressure for a predetermined period of time, wherein a color change is visible on the substrate at a specific location or locations on the item where the ozone gas has exited the item and reacted with the reagent on the flexible substrate.

This patent application claims the benefit of U.S. Provisional Patent Application Ser. No. 63/631,134 filed on Apr. 8, 2024 and entitled “Colorimetric Gas Leak Detection”, the disclosure of which is hereby incorporated by reference herein in its entirety and made part of the present U.S. utility patent application for all purposes.

### BACKGROUND

The disclosed technology relates in general to systems and methods for quality assurance in manufacturing, and more specifically to a colorimetric gas leak detection system for use with various manufactured parts and components.

A tier 1 vendor is defined as a company that acts as a direct supplier for an original equipment manufacturer (OEM). The tier 1 vendor supplies independent parts in the automotive sector, such as motors, car seats, brakes, etc. Many tier 1 automotive suppliers and OEMs are also heavily involved in the manufacturing of electric vehicles. The battery enclosure (and its contents) is an expensive part of the vehicle, and an OEM will only accept the battery enclosure if it is leak-free. Leak testing and the subsequent repair of leak locations on battery enclosures is not trivial regarding such a large subcomponent and may involve considerable effort. Existing leak testing methods such as helium leak testing, pressure decay, vacuum decay, and submersed bubble do not mark the precise spot of a leak, thereby limiting the utility of such methods. Accordingly, there is an ongoing need for a leak detection system and method that is cost-effective, accurate, and relatively easy to perform with regard to battery enclosures and other manufactured items, such as automotive pumps, oil and gas pipelines, medical devices, and consumer goods.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One embodiment of the disclosed technology provides a system for detecting gas leaks, comprising a chemical reagent that includes a saturated aqueous solution of a predetermined metal ionic powder; a flexible substrate configured to receive the chemical reagent, wherein the flexible is also configured to be affixed to the exterior of an item to be leak tested; a source of ozone gas, wherein the ozone gas is flowed into the item to be leak tested under a predetermined pressure for a predetermined period of time, wherein a color change is visible on the substrate at a specific location or locations on the item where the ozone gas has exited the item and reacted with the reagent on the flexible substrate.

Embodiments of the system further comprise a vacuum configured to remove ambient air from the item to be leak tested prior to flowing the ozone gas into the item. In certain implementations, the predetermined metal ionic powder changes color when the oxidative state of the metal changes. In certain implementations, the metal ionic powder includes chromium, iron, cobalt, or potassium. In certain implementations, other chemicals such as carboxymethyl cellulose, cationic or anionic hydroxyethyl cellulose, starch, modified starch, amylose, dextrin, styrene maleic anhydride, styrene butadiene latex, styrene acrylic, polyethyleneimine, and blue or violet dyes are or may be present. In certain implementations, the flexible substrate is paper, tape, a hydrogel, a sponge, or an adsorbent solid. In various implementations, the item to be leak tested is a battery enclosure for electric vehicles, a vacuum pump, a high-pressure fitting, a refrigeration unit, or fluid transfer tubing. In certain implementations, a gas leak can be detected in a period of about six minutes using the system.

Another implementation of the disclosed technology provides a first method for detecting gas leaks, comprising creating a chemical reagent that includes a saturated aqueous solution of a predetermined metal ionic powder; applying the reagent to a flexible substrate; affixing the flexible substrate to the exterior of an item to be leak tested; flowing ozone gas into the item to be leak tested under a predetermined pressure for a predetermined period of time; and visualizing a color change on the substrate at a specific location or locations on the item where the ozone gas has exited the item and reacted with the reagent on the flexible substrate.

Certain implementations include the step of adding carboxymethyl cellulose, cationic or anionic hydroxyethyl cellulose, starch, modified starch, amylose, dextrin, styrene maleic anhydride, styrene butadiene latex, styrene acrylic, polyethyleneimine, or blue or violet dyes or combinations thereof. In certain implementations of the method, the predetermined metal ionic powder changes color when the oxidative state of the anion or cation within the ionic powder changes. In certain implementations, the metal ionic powder includes chromium, iron, cobalt, or potassium. In certain implementation, anions include permanganate, iodide, chloride, or hydroxide. In certain implementations, the flexible substrate is paper, tape, a hydrogel, a sponge, or an adsorbent solid. In various implementations, the item to be leak tested is a battery enclosure for electric vehicles, a vacuum pump, a high-pressure fitting, a refrigeration unit, or fluid transfer tubing. In certain implementations, a gas leak can be detected in a period of about six minutes from initiating the method. In certain implementations, the method is fully or partially automated.

Still another implementation of the disclosed technology provides a second method for detecting gas leaks, comprising creating a chemical reagent that includes a saturated aqueous solution of a predetermined metal ionic powder; applying the reagent to a flexible substrate; affixing the flexible substrate to the exterior of an item to be leak tested; using a vacuum to remove ambient air from the item to be leak tested; flowing ozone gas into the item to be leak tested under a predetermined pressure for a predetermined period of time; visualizing a color change on the substrate at a specific location or locations on the item where the ozone gas has exited the item and reacted with the reagent on the flexible substrate; removing the substrate from the item; and repairing the detected leak.

Certain implementations include the step of adding carboxymethyl cellulose, cationic or anionic hydroxyethyl cellulose, starch, modified starch, amylose, dextrin, styrene maleic anhydride, styrene butadiene latex, styrene acrylic, polyethyleneimine, or blue or violet dyes or combinations thereof. In certain implementations of the method, the predetermined metal ionic powder changes color when the oxidative state of the anion or cation within the ionic powder changes. In certain implementations, the metal ionic powder includes chromium, iron, cobalt, or potassium. In certain implementation, anions include permanganate, iodide, chloride, or hydroxide. In certain implementations, the flexible substrate is paper, tape, a hydrogel, a sponge, or an adsorbent solid. In various implementations, the item to be leak tested is a battery enclosure for electric vehicles, a vacuum pump, a high-pressure fitting, a refrigeration unit, or fluid transfer tubing. In certain implementations, a gas leak can be detected in a period of about six minutes from initiating the method.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, serve to explain the principles of the disclosed subject matter, and wherein:

FIG. 1 is a flow chart depicting an example implementation of the disclosed colorimetric system and method for gas leak detection; and

FIGS. 2A-2C are images of the disclosed system and method being used to detect a gas leak, wherein FIG. 2A shows a test item having an aperture formed therein, wherein FIG. 2B shows the reagent-containing flexible substrate placed over the aperture, and wherein FIG. 3C shows a visible color change where ozone gas has passed through the aperture and contacted the reagent-containing flexible substrate.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The disclosed technology provides a system and method for detecting gas leaks in various manufactured items such as battery enclosures for electric vehicles, vacuum pumps, high pressure fittings, refrigeration units, fluid transfer tubing, and other items. If the item being leak tested can be repaired, then it is important to understand where the leak is occurring so that the leak can be mitigated. Likewise, if leak testing is part of a failure analysis, then understanding where the leak is occurring is important for implementing a solution for that failure, be it design, processing, or materials related. This system and method is based a chemical reaction that produces a visible color change on a flexible substrate that has been saturated with a predetermined chemical solution when the saturated substrate is exposed to a particular gas. The flexible substrate is attached to an item to be leak tested and gas is pumped into and through the item at a predetermined rate and at a predetermined pressure. Gas will flow through a leak path (e.g., void, microchannel, crack, etc.) and as gas exits the item being tested, it contacts the saturated flexible membrane at specific locations and a visible color change occurs on the substrate. The color change is distinct and permanent and marks leak locations. This marking allows battery manufacturers to quickly and easily determine if and where any leaks are present so such leaks can be repaired before shipping the unit to the OEM.

Example implementations of the disclosed technology include the following basic components: (i) a suitable reactive gas or a generator for creating a suitable reactive gas; (ii) a suitable color-change reagent; (iii) a suitable substrate for the color-change reagent; and (iv) a pressurization device and connective tubing. A suitable gas was identified using the following selection criteria: (a) low toxicity at a concentration promoting color change; (b) non-flammable; (c) non-damaging to batteries or other materials in battery box (e.g., bus bars, thermal barriers, etc.); (d) inexpensive; (e) abundant; and (f) not found in ambient air at appreciable concentrations. A suitable color-change reagent was identified using the following selection criteria: (a) non-toxic; (b) non-flammable; (c) non-damaging; (d) inexpensive; (e) abundant, and (f) capable of changing color when exposed to the selected gas, but not when exposed to ambient air. The color change should be easy to identify visually, permanent, and should occur within seconds at low concentrations.

In an example implementation, ozone (O₃) is used as the reactive gas. The Occupational Safety and Health Administration (OSHA) permissible exposure limit (PEL) for ozone is 0.1 ppm average over an 8-hour shift. Color change chemicals transition at concentrations as low as 0.05 ppm, so the reaching the OSHA PEL is avoidable. Furthermore, the volume of O₃ escaping into an auto plant during leak testing is minimal, so no special enclosures are needed to house battery enclosures or other items during testing using the disclosed method. Ozone is non-flammable. Ozone can be damaging to polymers and metals by causing oxidation, but the concentration required and the short duration of the disclosed testing methodology is not be enough to cause damage to the materials being tested. An ozone generator is inexpensive and the gas produced is abundant. Ozone is an unstable molecule, so it cannot be purchased in tanks, but it is also not present in air. In an example implementation, the color-change reagent is any metal ionic powder that changes color when the oxidative state of the metal changes. The metal ionic powder may be, for example, chromium, iron, cobalt, or potassium. In the validating experiments described below, a saturated potassium-based solution was used. Within seconds of exposure to low concentration ozone, the solution changed permanently from clear to purple. The flexible substrate is paper, tape, a hydrogel, a sponge, or an adsorbent solid (e.g., zeolite).

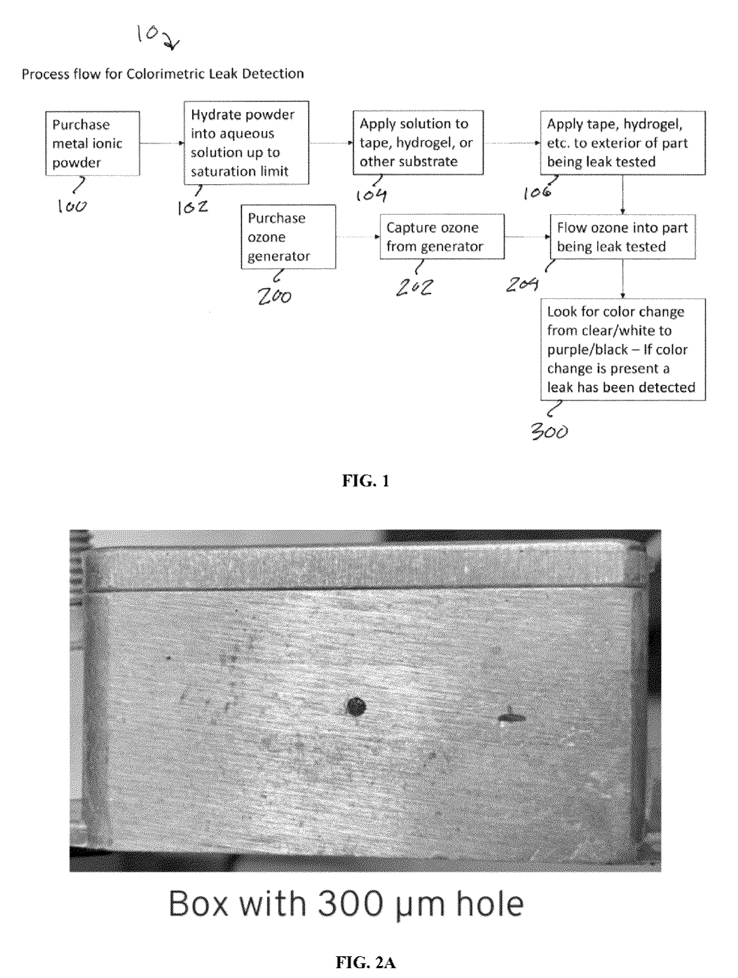

FIG. 1 provides a flow chart depicting an example implementation of colorimetric method for gas leak detection 10. Regarding this method, metal ionic powder is selected or obtained at process step 100; the ionic powder is hydrated into an aqueous solution up to the saturation limit of the solution at process step 102; the solution is applied to a tape, hydrogel, or other substrate at process step 104; the tape, hydrogel, or other substrate is applied to the exterior of a part being leak tested and process step 106; an ozone generator is obtained at process step 200; ozone gas is captured from the ozone generator at process step 202; the ozone is pumped or flowed into the part being leak tested at process step 204; and a color change (e.g., clear to white or purple to black) is visualized at process step 300 if a leak has been detected.

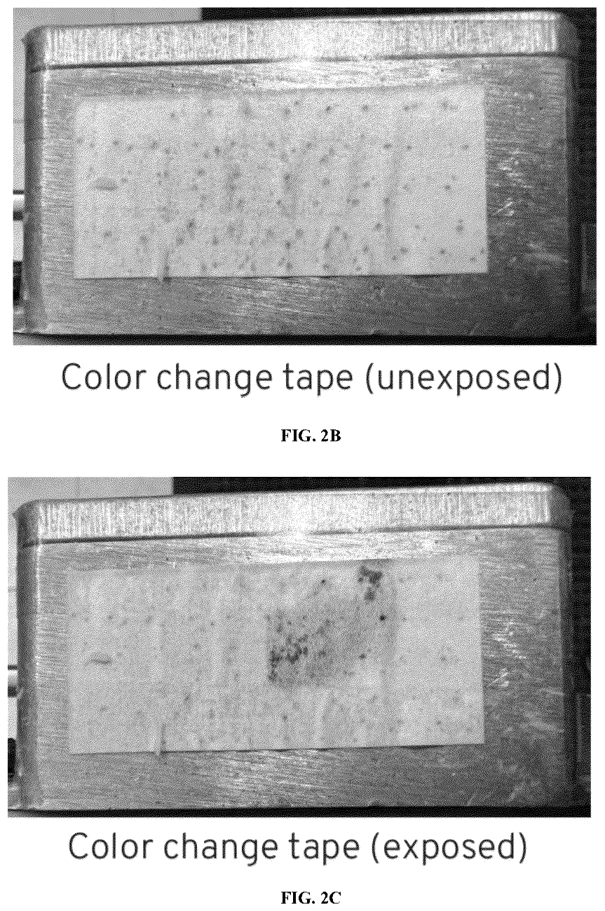

With reference to FIGS. 2A-2C, validation of the disclosed system and method was performed on a battery enclosure. A small aluminum box (volume of ˜83 cc) with an IP67 rating was utilized for demonstrating feasibility. A low-pressure barbed hose fitting was secured through a first box wall and ozone was injected at this location. A 300 μm diameter hole was formed in a second box wall to simulate porosity occurring during welding or sealing. Flexible tape saturated with the reagent was first perforated and then affixed to the aluminum box over the known leak location. Perforation of the flexible tape allowed ozone to flow to the outer surface of the tape where the color resultant change was more easily detected and visualized. The reagent turned purple where hole was located.

An example method for leak detection in a manufacturing environment using the disclosed technology includes the following steps: (i) a product (component, part, etc.) is manufactured per standard manufacturing specifications and protocols; (ii) the chemical reagent tape is placed on the product or sprayed on wet during a time period of about 5 minutes; (iii) ambient air is vacuumed out of the product for a time period of about 2 minutes (note: test parts having low internal volume do not require removing ambient air with a vacuum); (iv) the challenge gas is injected into the product for a time period of about 2 minutes at a known or predetermined pressure; (v) the product is moved to a subsequent manufacturing station and visually inspected for a time period of about 2 minutes; and (vi) the indicator tape is removed from the product over a time period of about 2 minutes.

Advantages of the disclosed technology include the following characteristics: (i) the test system and method generates qualitative feedback with a very limited cycle time (e.g., within seconds); (ii) the system and method can be used directly on a manufacturing line; (iii) detection of leaks can be visualized by the human eye or by cameras or other sensors; (iv) leak location can be marked for future reworking of the item being tested; (v) water dip tanks are not required for testing; and (vi) more complex equipment such as helium wands and mass spectrometers are not require for testing.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for detecting gas leaks, comprising:
(a) a chemical reagent that includes a saturated aqueous solution of a predetermined metal ionic powder;
(b) a flexible substrate configured to receive the chemical reagent, wherein the flexible is also configured to be affixed to the exterior of an item to be leak tested;
(c) a source of ozone gas, wherein the ozone gas is flowed into the item to be leak tested under a predetermined pressure for a predetermined period of time,
(e) wherein a color change is visible on the substrate at a specific location or locations on the item where the ozone gas has exited the item and reacted with the reagent on the flexible substrate.

2. The system of claim 1, further comprising a vacuum configured to remove ambient air from the item to be leak tested prior to flowing the ozone gas into the item.

3. The system of claim 1, further comprising carboxymethyl cellulose, cationic or anionic hydroxyethyl cellulose, starch, modified starch, amylose, dextrin, styrene maleic anhydride, styrene butadiene latex, styrene acrylic, polyethyleneimine, or blue or violet dyes or combinations thereof.

4. The system of claim 1, wherein the predetermined metal ionic powder changes color when the oxidative state of the metal changes.

5. The system of claim 1, wherein the metal ionic powder includes chromium, iron, cobalt, or potassium.

6. The system of claim 1, wherein the flexible substrate is paper, tape, a hydrogel, a sponge, or an adsorbent solid.

7. The system of claim 1, wherein the item to be leak tested is a battery enclosure for electric vehicles, a vacuum pump, a high-pressure fitting, a refrigeration unit, or fluid transfer tubing.

8. The system of clam 1, wherein a gas leak can be detected in a period of about six minutes using the system.

9. A method for detecting gas leaks, comprising:
(a) creating a chemical reagent that includes a saturated aqueous solution of a predetermined metal ionic powder;
(b) applying the reagent to a flexible substrate;
(c) affixing the flexible substrate to the exterior of an item to be leak tested;
(d) flowing ozone gas into the item to be leak tested under a predetermined pressure for a predetermined period of time; and
(e) visualizing a color change on the substrate at a specific location or locations on the item where the ozone gas has exited the item and reacted with the reagent on the flexible substrate.

10. The method of claim 9, further comprising adding carboxymethyl cellulose, cationic or anionic hydroxyethyl cellulose, starch, modified starch, amylose, dextrin, styrene maleic anhydride, styrene butadiene latex, styrene acrylic, polyethyleneimine, or blue or violet dyes or combinations thereof.

11. The method of claim 9, wherein the predetermined metal ionic powder changes color when the anion or cation within the ionic powder changes.

12. The method of claim 9, wherein the metal ionic powder includes chromium, iron, cobalt, or potassium.

13. The method of claim 9, wherein the anions include permanganate, iodide, chloride, or hydroxide.

14. The method of claim 9, wherein the flexible substrate is paper, tape, a hydrogel, a sponge, or an adsorbent solid.

15. The method of claim 9, wherein the item to be leak tested is a battery enclosure for electric vehicles, a vacuum pump, a high-pressure fitting, a refrigeration unit, or fluid transfer tubing.

16. The method of claim 9, wherein a gas leak can be detected in a period of about six minutes from initiating the method.

17. The method of claim 9, wherein the method is fully or partially automated.

18. A method for detecting gas leaks, comprising:
(a) creating a chemical reagent that includes a saturated aqueous solution of a predetermined metal ionic powder;
(b) applying the reagent to a flexible substrate;
(c) affixing the flexible substrate to the exterior of an item to be leak tested;
(d) using a vacuum to remove ambient air from the item to be leak tested;
(e) flowing ozone gas into the item to be leak tested under a predetermined pressure for a predetermined period of time;
(f) visualizing a color change on the substrate at a specific location or locations on the item where the ozone gas has exited the item and reacted with the reagent on the flexible substrate;
(g) removing the substrate from the item; and
(h) repairing the detected leak.

19. The method of claim 18, further comprising adding carboxymethyl cellulose, cationic or anionic hydroxyethyl cellulose, starch, modified starch, amylose, dextrin, styrene maleic anhydride, styrene butadiene latex, styrene acrylic, polyethyleneimine, or blue or violet dyes or combinations thereof.

20. The method of claim 18, wherein the predetermined metal ionic powder changes color when the anion or cation within the ionic powder changes.

21. The method of claim 18, wherein the metal ionic powder includes chromium, iron, cobalt, or potassium.

22. The method of claim 18, wherein the anions include permanganate, iodide, chloride, or hydroxide.

23. The method of claim 18, wherein the flexible substrate is paper, tape, a hydrogel, a sponge, or an adsorbent solid.

24. The method of claim 18, wherein the item to be leak tested is a battery enclosure for electric vehicles, a vacuum pump, a high-pressure fitting, a refrigeration unit, or fluid transfer tubing.

25. The method of claim 18, wherein a gas leak can be detected in a period of about six minutes from initiating the method.
